(19) United States
(12) Patent Application Publication
(10) Pub. No.: US 2011/0202264 A1
(43) Pub. Date: Aug. 18, 2011

(54) METHOD AND CONTROLLER FOR A STARTER DEVICE OF AN INTERNAL COMBUSTION ENGINE

(76) Inventor: Falco Sengebusch, Stuttgart-Feuerbach (DE)

(21) Appl. No.: 13/056,960

(22) PCT Filed: Jun. 16, 2009
(86) PCT No.: PCT/EP2009/057401

§ 371 Date: Apr. 21, 2011

(30) Foreign Application Priority Data
Aug. 6, 2008 (DE) 102008041040.3

(51) Int. Cl. F02D 28/00

(52) U.S. Cl. 701/113

(57) ABSTRACT

A method for controlling a starter device is described, having a starter motor, a meshing device and a starter pinion for meshing into a ring gear of an internal combustion engine in a motor vehicle, the meshing device for meshing the starter pinion being activated by the controller, in particular for a starting/stopping operating strategy. In order to improve vehicle comfort, in that the internal combustion engine may be restarted significantly more quickly, at least one meshing value of the meshing device for meshing the starter pinion is detected by a detecting device, stored in the controller as a reference value, and evaluated.

### FIELD OF THE INVENTION

The present invention relates to a method for controlling a starter device, having a starter motor, a meshing device, and a starter pinion for meshing into a ring gear of an internal combustion engine in a motor vehicle, the meshing device for meshing the starter pinion being activated by the controller, in particular for a starting/stopping operating strategy. In addition, the present invention relates to a computer program product and a controller for a starter device having a starter motor, a starter relay, and a starter pinion for starting an internal combustion engine in a motor vehicle, the controller being designed to have a microcomputer by means of which a starting/stopping operating strategy is executable.

### BACKGROUND INFORMATION

Conventionally, to save fuel and reduce emissions, the internal combustion engine in a vehicle is shut down by an engine controller, for example at traffic lights or because of traffic obstructions that force a temporary stop, after certain shut-down conditions, in particular after a certain time period. It is also conventional to start an internal combustion engine using a starter that has a starter pinion which is meshed into a ring gear of an internal combustion engine. For such a design of an internal combustion engine which is started with the aid of a starter pinion, there are minimum times for a restart which must be waited through before the internal combustion engine may be restarted, since the stationary start pinion must not be meshed into a rotating ring gear.

There are developments to mesh the starter pinion into the ring gear already while the internal combustion engine is coming to a stop.

German Patent Application No. DE 10 2006 011 644 A1 describes a device and a method for operating a device having a starter pinion and a ring gear of an internal combustion engine, in which the rotational speed of the ring gear and of the starter pinion are ascertained, in order to mesh the starter pinion at generally the same rotational speed after the internal combustion engine has been shut down while the internal combustion engine is coming to a stop. The starter pinion remains in a meshed state until the internal combustion engine starts rotating.

German Patent Application No. DE 10 2006 039 112 A1 describes a method for determining the rotational speed of the starter for a motor vehicle internal combustion engine. It is also described that the starting system includes its own starter control unit, in order to calculate the rotational speed of the starters, and to accelerate the pinion of the starter motor in starting/stopping operation if self-starting of the internal combustion engine is no longer possible due to a drop in rotational speed. The pinion is engaged with the ring gear of the decelerating internal combustion engine at generally synchronous speed.

German Patent Application No. DE 10 2005 004 326 A1 describes a starter device for an internal combustion engine having a separate engaging and starting process. To this end, the starter device has a control unit which activates a starter motor and an actuator for engaging a starter pinion separately. The pinion may be meshed into the ring gear by the control unit before a starting procedure of the motor vehicle, before the driver has expressed a new intent to start. In this case the actuator is activated as an engaging relay already during a deceleration phase of the internal combustion engine. The rotational speed threshold in this case is far below the idling speed of the engine, in order to keep the wear on the meshing device as low as possible. To prevent voltage dips in the on-board power supply due to a very high starting current for the starter motor, the controller implements a soft start, for example by pulsing the starter current. The performance capability of the on-board power supply is monitored by analyzing the battery condition, and the starter motor is pulsed or supplied with current accordingly. The crankshaft may be positioned shortly before or after the internal combustion engine has come to a stop, in order to shorten the starting time.

### SUMMARY

An object of the present invention is to refine a method, a computer program product and a controller of the type named at the beginning so as to improve vehicle comfort, in that restarting the internal combustion engine is executable significantly faster, simply, and with long life.

In accordance with an example embodiment of the present invention, the meshing time of a starter pinion is precisely ascertained using at least one previously detected meshing value, in order to mesh at an ideal point in time. The ideal point in time for meshing is a generally synchronous rotational speed of a starter pinion, accelerating or decelerating or at a constant speed, to be meshed into a ring gear or an internal combustion engine as it decelerates, Because of more precise values over the duration of meshing, the synchronous speed at which the meshing occurs may be increased significantly, so that it is possible to respond to changed operating wishes, such as restarting the internal combustion engine significantly faster than in the related art. Because a generally synchronous speed is reached in a smaller speed window and in a defined time window, the mechanical wear and noise development of the involved drive components, such as the starter device and the ring gear, are reduced to a minimum.

In accordance with an example method of the present invention, at least one meshing value of the meshing device for meshing the starter pinion is detected using a detecting unit, stored in the controller as a reference value, and evaluated. The detection of an individual meshing value in a vehicle is important, in order to compensate for manufacturing and assembly tolerances which occur in the production of motor vehicles. These manufacturing and assembly tolerances occur in a pinion travel of varying length before meshing occurs. The pinion travel may have tolerances of 1 mm to 5 mm, for example. This results in meshing at different points in time, depending on the manufacturing and assembly tolerances, which may be compensated for according to the example embodiment of the present invention by detecting the at least one meshing value. Hence it is possible, in a starting/stopping operating strategy, to mesh a starter pinion into the ring gear very precisely with a very high quality of synchronous rotational speed, both at low and at very high rotational speeds. The stored reference value is interpreted so that the starting time for meshing by the meshing device is shifted depending on the reference value, in order to execute the meshing at the proper time.

In order to detect the manufacturing and assembly tolerances that occur generally between the ring gear and the starter pinion, the meshing value is stored by the detecting device only when a tooth-to-tooth position occurs on meshing of the starting pinion with the ring gear. This meshing value differs from vehicle to vehicle, and is determined and set individually by the controller in order to improve the meshing quality.

According to one specific example embodiment that refines the present invention, a time period is measured as the meshing value. The reference value is therefore the time period until the starter pinion cannot be engaged with the ring gear of the internal combustion engine because of a tooth-to-tooth position. The time period varies, in particular since the pinion travel between starter pinion and ring gear varies slightly in length for reasons of manufacturing and assembly. In order to compensate for this installation tolerance during meshing of the starter pinion during a starting/stopping operating strategy, the reference value is detected and taken into account for the temporally defined activation of the meshing device.

According to one alternative specific embodiment, a travel distance of the starter pinion is measured directly as the meshing value. The reference value is read in and processed by the controller as a travel distance. The controller changes the activation of the meshing device depending on the travel distance, and thus compensates for the manufacturing tolerances. The travel distance may be measured using known detecting means.

According to one specific example embodiment that refines the present invention, the meshing device is designed as a starter relay, the starter pinion being meshed by means of a winding of the starter relay to which current may be applied, and a current of the starter relay which is influenced by the motion of the armature in the starter relay being detected and evaluated. Thus, a meshing value is achieved from the meshing winding, which serves to ascertain a reference value for timely activation of the starter relay. The meshing winding of the starter relay thus serves as sensor and as actuator, in a dual function.

According to one particularly preferred specific embodiment, the meshing device is designed as a starter relay having a first and a second winding to which current may be applied; due to the application of current to the first winding to achieve meshing the latter acts as the meshing winding, and an induced voltage is measured by the detecting device in the second winding, to which no current is applied. Thus, a starter relay may be employed multifunctionally as an actuator having two separately activatable windings, having a meshing winding and a switching winding to switch the starter current, the switching winding simultaneously acting as a sensor, in order to compensate for manufacturing tolerances. Through a simple electromagnetic principle, by measuring the induced voltage in the switching winding to which no current is applied, a time period until the tooth-to-tooth position is measured, which differs from vehicle to vehicle due to the manufacturing tolerances. This time period corresponds to a pinion travel distance, which serves as a reference value for predefined operating values of a starting/stopping operating strategy. The starting/stopping operating strategy is executed by the controller together with an engine controller.

Advantageously, the time period before initial operation of the vehicle is measured. The manufacturing tolerance, which differs from vehicle to vehicle, is usually determined only once in the lifetime of the vehicle. Initial operation is thus to be understood as the point in time after production of the vehicle but before it is turned over to the vehicle owner. An initial operation also occurs after repair work on the internal combustion engine or the starter motor, if the installation tolerances could have been changed thereby. Before the initial operation of the vehicle, the controller adjusts itself through “self-learning” diagnostic functions according to the method according to the present invention.

According to one alternative specific example embodiment, the manufacturing tolerances are measured by the controller over the time period in predefined cycles, for example by constant travel distances or constant time periods, and the reference value is updated as appropriate. This is beneficial in order to compensate for tolerances, which occur for example due to wear on the starter pinion or ring gear, to increase the service life. Premature wear is thereby reduced.

The object may be achieved using a computer program product, in that it is loadable into a program memory together with program commands in order to execute all of the steps of the method described above when the program is executed in a controller.

The computer program product does not necessitate any additional components in the vehicle, but rather may be implemented as a module in controllers that are already present, in the vehicle. The computer program product may be provided, for example, in the engine controller or a controller for the starter device, i.e., a starter controller. The computer program product has the additional advantage that it is easily adaptable to individual and specific customer wishes, as well as enables an improvement to the operating parameters due to improved empirical values, and that a self-learning function is implementable.

In addition, the object may also achieved by a controller in that the controller has a program memory and a detecting device, using which characteristic current values are measurable at the starter relay when current is applied to a meshing winding, these current values being analyzable as measured meshing values and storable in the program memory for processing. Thus, using the controller in combination with a two-stage starter relay having at least one winding, a measuring and sensor system is created in order to compensate for installation tolerances, to thus achieve a high quality for the point in time of meshing the starter pinion with the ring gear of the internal combustion engine at a synchronous rotational speed of the starter motor. The service life is thus long, the noise development is low, and with starting/stopping operating strategies the availability of the internal combustion engine is made known more quickly.

According to another preferred specific embodiment, the controller is designed to have a program memory into which in particular a computer program product described above is loadable, in order to preferably execute the method described above.

The features identified above and explained below are usable not only in the particular combination indicated, but also in other combinations.

### BRIEF DESCRIPTION OF THE DRAWINGS

The present invention explained in greater detail below on the basis of an exemplary embodiment, with reference to figures.

FIG. 1 shows a schematic circuit diagram of drive components of a vehicle.

FIG. 2 shows a flow chart for a method according to the present invention.

FIG. 3 shows a signal characteristic diagram of a meshing method.

### DETAILED DESCRIPTION OF EXAMPLE EMBODIMENTS

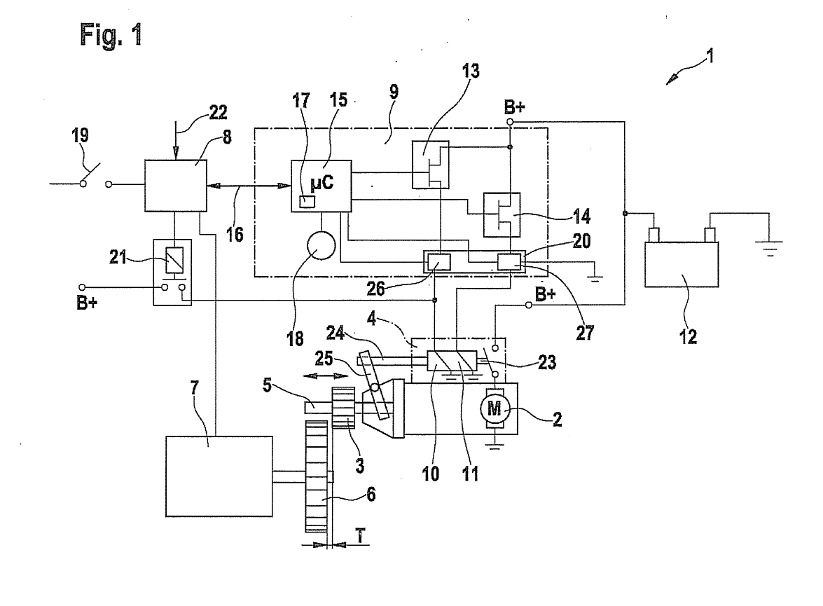

FIG. 1 shows a circuit diagram of a starter device 1. Starter device 1 includes a starter motor 2, having a starter pinion 3 which is axially movable by a starter relay 4 as a meshing device on a starter axis 5 of starter motor 2. Starter pinion 3 is engaged by starter relay 4 with a ring gear 6 of an internal combustion engine 7 to start internal combustion engine 7.

In the disengaged state there is, between the face of starter pinion 3 on the ring gear side and the face of ring gear 6 on the starter pinion side, a pinion-ring gear gap T, for example on the order of 1 to 5 mm. Gap T differs from vehicle to vehicle due to manufacturing and assembly tolerances.

Starter device 1 depicted in FIG. 1 is provided according to the example embodiment of the present invention in order to execute a starting/stopping operating strategy, according to which a quick restart of internal combustion engine 7 is possible. Internal combustion engine 7 is shut down by engine controller 8 on the basis of a starting/stopping operating strategy. To guarantee quick availability of the internal combustion engine, starter pinion 3 is accelerated to a synchronous rotational speed with ring gear 6. The rotational speed of the ring gear approaches the synchronous rotational speed as the rotational speed decreases. In order to achieve the best possible synchronization of the two rotational speeds approaching each other, according to the present invention a controller, referred to hereinafter as starter controller 9, knows in which time period starter pinion 3 impacts ring gear 6 from the rest position. To determine this time period for meshing, which depends on a varying installation tolerance of gap T, the example method described below is carried out. In order to carry out the example method according to the present invention for improving starting/stopping operating strategies, in particular with a quick change in the driver's wish to operate the internal combustion engine, the starter device has in particular the following features and components.

According to one particularly preferred specific embodiment, starter relay 4 is designed to have two windings which are separately activatable by starter controller 9, a first and a second winding. The first winding is a so-called meshing winding 10, in order to mesh starter pinion 3 into ring gear 6 separately from an application of current to starter motor 2. A switching winding 11 switches the maximum starter current from battery 12 to activate starter motor 2. Meshing winding 10 and switching winding 11 are connected to starter controller 9 through a special switching system, which is depicted in FIG. 1 in abstract and simplified form. It goes without saying that the switching system of starter controller 9, together with starter relay 4 and starter motor 2, may also have other preferred switching systems, the main components being depicted in FIG. 1.

To activate meshing winding 10 and the switching winding, starter controller 9 includes electronic power switches 13, 14, which may also be designed as relays. Power switches 13, 14 are activated by a microcomputer 15 built into starter controller 9. Microcomputer 15 is in informational contact with the engine controller via a bus system 16, for example a CAN bus, in order to be able to receive information signals for starting starter motor 2 and starter relay 4 and to be able to accept pulse signals to execute a starting/stopping operating strategy. Starting/stopping operating strategies are stored in a program memory 17 in microcomputer 15. Microcomputer 15 has a timer 18 for execution.

According to the present invention, starter controller 9 has a detecting device 20, which measures an induced voltage at switching winding 11 against ground over time using a voltage measuring device 27, and conveys these voltage values to microcomputer 15.

Alternatively, detecting device 20 has a current measuring device 26, which detects the current of meshing winding 10 and conveys the variation of these values over time to microcomputer 15.

Microcomputer 15 evaluates the measured values with the aid of timer 18, and adjusts the timing of the starting pulse for meshing starter pinion 3 using starter relay 4, according to the figures described below.

To execute cold starts, engine controller 8 is activated by closing a switch 19, for example at the ignition lock, which closes a separate relay 21 in order to apply current to starter relay 4 and starter motor 2.

To enable engine controller 8 to detect shut-down conditions, it is connected to a second bus system, for example a LIN bus 22. LIN bus 22 supplies sensor values, for example the velocity of the vehicle, the accelerator, clutch and/or brake pedal positions, etc., in order to deduce therefrom whether the shut-down conditions for a starting/stopping operating strategy are present.

To measure the gap of installation tolerance T, which clearly affects the length of time for meshing starter pinion 3 into ring gear 6, the duration of the starting pulse due to the application of current until starter pinion 3 hits ring gear 6 is measured from meshing winding 10. This is important in order to derive therefrom the effective time period for meshing and to enable synchronous meshing at the correct point in time even when ring gear 6 and starter pinion 3 are rotating at high speed, so as to minimize noise development and wear and to optimize the effectiveness of the starter device.

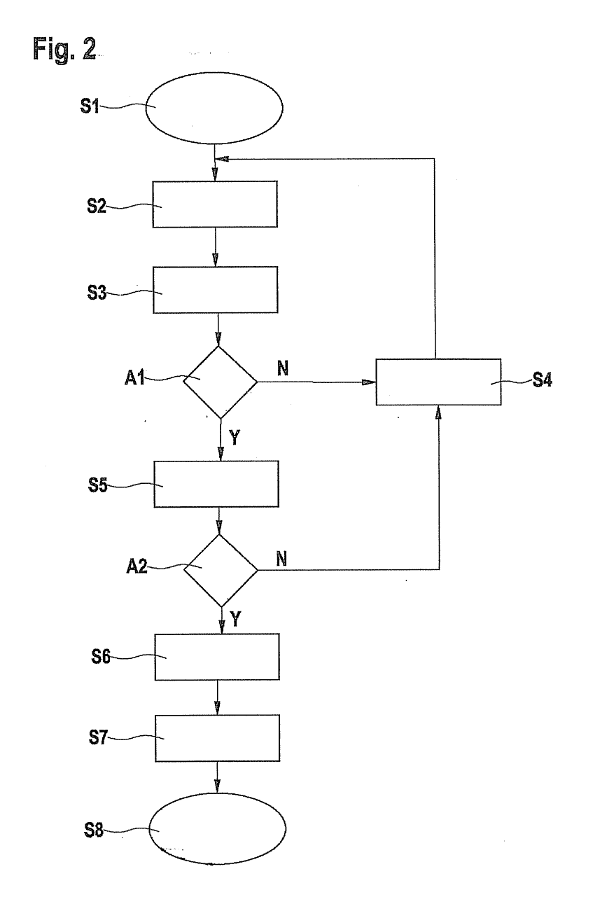

FIG. 2 shows, as an exemplary flow chart, the process sequence of a starter controller 9 in order to set the installation tolerance of the pinion-ring gear gap T. The process sequence is preferably carried out prior to commencement of the starting/stopping operating strategy. Alternatively, it is possible to repeat the process sequence in certain cycles, for example after constant travel distances, for example every 50,000 or 100,000 km, or at time intervals, for example once each year or always before every cold start, in order to check the gap, which could have changed due to wear. Naturally, the process sequence also must be repeated after a repair to the involved vehicle components. The process sequence may also be performable when there are great temperature differences, which may result in a changeable installation tolerance with gap T.

In step S1, starter controller 9, in particular microcomputer 10, receives a signal to carry out the process that is loaded into program memory 17 as a computer program having program commands, for example after production of the vehicle, when the vehicle is started for the first time using the ignition key, and switch 19 is operated.

In step S2, meshing winding 10 is supplied with current via power switch 13, so that starter pinion 3 moves toward ring gear 6.

In step S3, detecting device 20, using a voltage measuring device 27, detects an induced voltage from switching winding 11 in starter relay 4 over time due to the motion of armature 24, which moves starter pinion 3 axially on axis 5 via a fork lever 25. The voltage values obtained over time are conveyed by detecting device 20 to microcomputer 15. Microcomputer 15 evaluates the voltage values over time according to a characteristic value curve, and calculates the duration of the meshing process, including a characteristic value curve. There are two characteristic value curves, a first and a second. The first characteristic value curve corresponds to a non-meshed starter pinion 3, i.e., a tooth-to-tooth position of starter pinion 3 and ring gear 6. The second characteristic value curve indicates a starter pinion 3 meshed into ring gear 6.

Alternatively or in addition, detecting device 20 is designed to have a current measuring device 26 which measures the current 110 of meshing winding 10. Current 110 is reduced due to the motion of armature 24 due to an induced voltage. The cause of the induced voltage is the change is inductance of the coil due to the moving armature. Microcomputer 15 evaluates either a curve from voltage measuring device 27 or from current measuring device 26, or both measured value curves. The first characteristic value curve results from a curve of the current or voltage which is typical for reaching a tooth-to-tooth position, for example due to local plateaus and/or extreme values at a particular, application-dependent level.

In a query A1, microcomputer 15 distinguishes whether the characteristic value curve evaluated in step S3 lies within a predefined tolerance range or not, i.e., whether the characteristic value curve is the first or second characteristic value curve. If the first characteristic value curve lies within the tolerance range, then microcomputer 15 detects a tooth-to-tooth position of starter pinion 3 and ring gear 6.

If the detected value curve lies outside the tolerance range, i.e., if it is the second characteristic value curve, then there is no tooth-to-tooth position present and starter pinion 3 has been meshed into ring gear 6. Hence it was not yet possible to measure the gap of installation tolerance T.

If a tooth-to-tooth position has not been reached, starter pinion 3 is unmeshed again, by switching off the current of meshing winding 10. Steps S2, S3, and A1 are repeated. To achieve a different initial position of starter pinion 3, starter motor 2 may additionally be started by rotating via a small initial rotation current, using a controller which has been omitted for reasons of simplification.

Thus, in step S4 starter pinion 3 is rotated relative to ring gear 6, in order be detect gap T as a time period in a repeated pass through steps S2 and S3 and query A1.

If the evaluated first characteristic value curve lies within the tolerance range, then the duration of the meshing is stored as the meshing duration value in step S5. This meshing duration value forms a reference value, in order to derive therefrom the ideal meshing time and hence the ideal, i.e., the best possible starting time for meshing starter pinion 3, through execution of a computer program product by microcomputer 15.

According to one alternative specific embodiment, in a query A2 a counter is installed, in order to repeatedly run through gap T via the process having steps S2 and S3 and thus to confirm the reference value. For example, the reference value is only finally stored when the reference value from step S5 has been confirmed three times or a mean value is found. This occurs in step S6. The meshing process is also carried out repeatedly in order to compensate for measuring errors. The meshing process in a tooth-to-tooth position occurs in approximately 70% of cases. Thus repetitions are necessary due to a tooth-to-gap position in at least approximately 30% of cases.

In step S6, the reference value is stored in the program memory at least for the lifetime of the vehicle, or until the next reference measurement.

In step 7, microcomputer 15 calculates starting point in time tₒ and shifts starting point in time tₒ either forward or backward from a neutral target reference value.

In step S8 the process is ended and starter controller 9 is set for a starting/stopping operating strategy, wherein starter toothed starter pinion 3 is synchronously meshable very well into ring gear 6 even at a very high rotational speed.

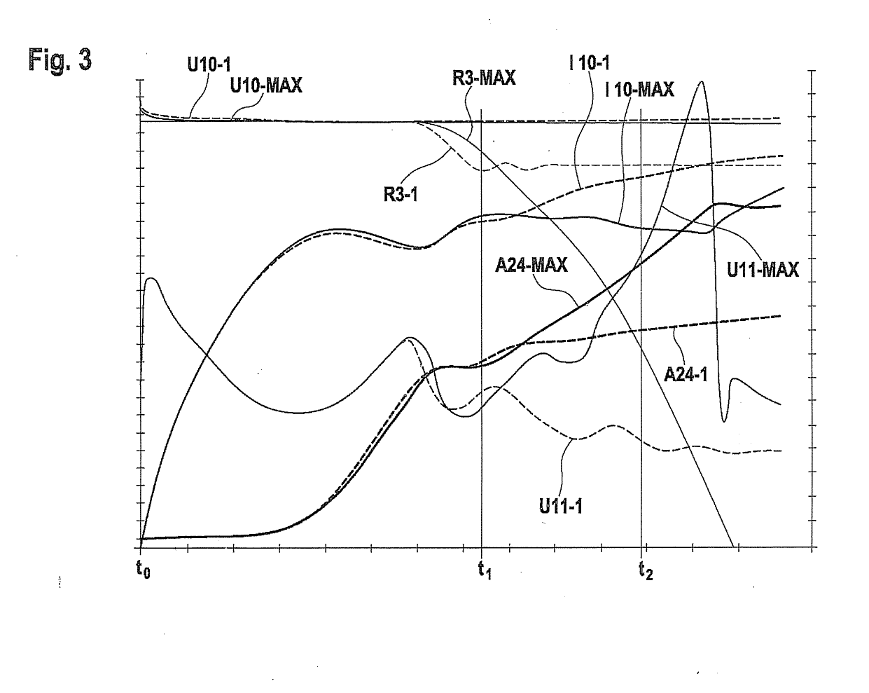

FIG. 3 shows by way of example a time-current-voltage-distance diagram, with characteristic curves of voltage U10 of meshing winding 10, current 110 of meshing winding 10, axial motion distance R3 of starter pinion 3, axial motion distance A24 of armature 24 and induced voltage U11 of switching winding 11, in each case for a tooth-to-tooth position with a gap of installation tolerance T of for example 1 mm, designated as −1, and a complete meshing process of starter pinion 3 into ring gear 6, designated below by −max.

FIG. 3 makes it clear that current 110 of meshing winding 10 and/or induced voltage U11 is measured over time and evaluated, i.e., how starter relay 4 is employable simultaneously as actuator and sensor.

The magnetic flux changes in meshing winding 10 due to the motion of armature 24, and a voltage U is induced which is directed contrary to voltage U10 applied from outside, and thus reduces the current according to characteristics I4-1 and I4-max.

The current variation is detected and evaluated in starter controller 9 or some other separate controller, or for example if starter controller 9 is integrated into engine controller 8.

When current is applied to meshing winding 10, current 110 rises as the gradient decreases, due to the inductivity of the winding in starter relay 4. Accordingly, induced voltage U11 due to the motion of armature 24 and the magnafluxing through meshing winding 10 in starter controller 9 is measurable at voltage measuring device 27 in the current path of switching winding 11, and may be evaluated according to the method described in reference to FIG. 2. Current 110 of the meshing winding is likewise measurable and analyzable with the aid of current measuring device 26.

If the end face of starter pinion 3 hits ring gear 6 due to a tooth-to-tooth position, for example after a pinion travel of 1 mm at a particular point in time t₁, the induced voltage decreases according to characteristic U11-1, whereas characteristic U11-max of the induced voltage rises sharply in the event of a complete motion of armature 24 due to engagement of a tooth-to-gap position, as shown in FIG. 3.

A tooth-to-tooth position is also deducible from characteristic curve I10 of the current of meshing winding 10, since the current continues to rise according to characteristic curve I10-1 when an impact occurs, for example after 1 mm of pinion travel, since induced voltage U drops because the motion of armature 24 is stopped.

However, in the case of a maximum motion of armature 24, induced voltage U rises according to characteristic U11-max, so that current I10-max is again somewhat reduced.

In the case of an installation position with a small gap between starter pinion 3 and ring gear 6, the delay of armature 24 and the repeated rise of current I10-1 occur earlier than point in time t₁. Conversely, in the case of an installation position with a larger gap between starter pinion 3 and ring gear 6, point in time t₁ shifts backward. By measuring this time period t₁, it is possible to deduce the installation position of the gap, and to correct the meshing period accordingly using a reference value and to save it. The process described in FIG. 2 and depicted by the characteristic curves in FIG. 3 may be set either at the beginning of the service life of a vehicle or after every key start, or after defined constant intervals of distance traveled or passage of a period of time.

FIG. 3 shows a point in time t₂. At this point in time, the starter controller has determined that the measured value, either current 110 of meshing winding 10 and/or induced voltage till at switching winding 11, is executing a maximum motion of armature 24, since starter pinion 3 is completely meshed into ring gear 6 due to a tooth-to-gap position. Point in time t₂ thus lies outside the tolerance range of query A1 from FIG. 2, so that starter controller 9 detects complete meshing and repeats measuring processes as appropriate according to the process sequence described in FIG. 2.

All figures show merely schematic illustrations, not to scale. Otherwise reference is made to the depiction in the drawing as needed for the present invention in particular.

1-11. (canceled)

12. A method for controlling a starter device having a starter motor, a meshing device, and a starter pinion for meshing into a ring gear of an internal combustion engine in a motor vehicle, the meshing device for meshing the starter pinion being activated by the controller for a starting/stopping operating strategy, the method comprising:
detecting by the meshing device at least one meshing value for meshing the starter pinion with the aid of a detecting device;
saving the at least one meshing value as a reference value; and
evaluating the meshing value in the controller to determine when to activate the starter pinion.

13. The method as recited in claim 12, wherein the meshing value at which the starter pinion forms a tooth-to-tooth position when meshing with the ring gear is measured by the detecting device.

14. The method as recited in claim 12, wherein the meshing value is measured as a length of time for meshing the starter pinion.

15. The method as recited in claim 12, wherein the meshing value is measured as a travel distance of the starter pinion.

16. The method as recited in claim 12, wherein the meshing device is a starter relay, the starter pinion being meshed using a winding of the starter relay to which current may be applied, and a current of the starter relay being detected and evaluated which is influenced by a motion of an armature in the starter relay.

17. The method as recited in claim 12, wherein the meshing device is a starter relay having two windings to which current may be applied separately, at least one first winding being designed as a meshing winding, and when meshing occurs, the detecting device measures an induced voltage in the second winding, to which no current has been applied.

18. The method as recited in claim 14, wherein the length of time is measured prior to initial operation of the vehicle.

19. The method as recited in claim 14, wherein the length of time is measured by the controller in predefined cycles and the reference value is updated.

20. A storage medium storing a computer program, the complete program being loadable into a program memory together with program commands, in order to execute all of the steps of a method when the program is executed in a controller, the method comprising:
detecting by a meshing device at least one meshing value for meshing a starter pinion with the aid of a detecting device;
saving the at least one meshing value as a reference value; and
evaluating the meshing value in the controller to determine when to activate the starter pinion.

21. A controller for a starter device having a starter motor, a starter relay and a starter pinion for starting an internal combustion engine in a vehicle, the controller having a microcomputer with the aid of which a starting/stopping operating strategy is executable, wherein the controller has a program memory and a detecting device using which characteristic current values are measurable at the starter relay when current is applied to a meshing winding, the current values being analyzable as a measured meshing value and being storable in the program memory for processing.

22. The controller as recited in claim 21, the program memory storing a computer program which, when executed by the controller, cause the controller to perform the steps of:
detecting by the meshing device at least one meshing value for meshing the starter pinion with the aid of a detecting device;
saving the at least one meshing value as a reference value; and
evaluating the meshing value in the controller to determine when to activate the starter pinion.
